(19) United States
(12) Patent Application Publication
(10) Pub. No.: US 2024/0167839 A1
(43) Pub. Date: May 23, 2024

(54) INFORMATION PROCESSING SYSTEM, CONTROLLER FOR VEHICLE, AND STORAGE MEDIUM

(71) Applicant: TOYOTA JIDOSHA KABUSHIKI KAISHA, Toyota-shi Aichi-ken (JP)

(72) Inventor: Koichi Suzuki, Miyoshi-shi (JP)

(73) Assignee: TOYOTA JIDOSHA KABUSHIKI KAISHA, Toyota-shi Aichi-ken (JP)

(21) Appl. No.: 18/382,613

(22) Filed: Oct. 23, 2023

(30) Foreign Application Priority Data
Nov. 18, 2022 (JP) 2022-185195

(51) Int. Cl. G01C 21/36

(52) U.S. Cl. CPC G01C 21/3685; G01C 21/3617; G01C 21/3682

(57) ABSTRACT

An information processing system includes execution circuitry and a storage that stores map data. The map data includes facility location information indicating a location of a specific facility, and parking lot location information. The execution circuitry is configured to determine that a vehicle has been parked in any one of the parking lots, when the vehicle is determined to have been parked in the parking lot, determine an approach route taken the vehicle to reach the parking lot and an approach direction toward the parking lot on the approach route, calculate a parking frequency of the vehicle that is parked in the parking lot for each combination of the approach route, the approach direction, and the parking lot, and store, in the storage, data related to the parking frequency in association with the map data for each combination of the approach route, the approach direction, and the parking lot.

### CROSS-REFERENCE TO RELATED APPLICATION

This application claims priority to Japanese Patent Application No. 2022-185195 filed on Nov. 18, 2022, incorporated herein by reference in its entirety.

### BACKGROUND

### 1. Field

The present disclosure relates to an information processing system, a controller for a vehicle, and a storage medium.

### 2. Description of Related Art

Japanese Laid-Open Patent Publication No. 2010-096890 discloses a map data generating system. The map data generating system includes a terminal device and a map server. The terminal device determines a movement trajectory of a vehicle on which the terminal device is mounted based on detection results of a GPS receiver and an acceleration sensor. Further, the terminal device identifies a deviation point at which the vehicle has deviated from a road based on the determined movement trajectory. Further, the terminal device identifies a get-out point at which the user has gotten out of the vehicle after the vehicle deviated the road. In addition, the terminal device identifies an arrival point at which the user has arrived on foot after the user got out of the vehicle. Then, the terminal device transmits information related to the deviation point, the get-out point, and the arrival point to a map server.

After receiving the information related to the deviation point, the get-out point, and the arrival point, the map server generates map data based on aggregated results of the information. Specifically, the map server defines, in the map data, the deviation point as a vehicle entrance corresponding to the arrival point. Further, the map server defines, in the map data, the get-out point as a parking lot corresponding to the arrival point.

In the map data generating system of the above publication, the map data stored in the map server includes multiple facilities and parking lots corresponding to the facilities. By using this map data, it is possible to guide a user to a parking lot of a specific facility when the user sets the facility as a destination. However, in a case in which there are multiple parking lots corresponding to a certain facility, the parking lot that is easiest to use for the user varies depending on the positional relationship between the user's current location and the facility. The map data generating system described in the above publication does not incorporate information that takes into account such convenience for users in the map data.

### SUMMARY

This Summary is provided to introduce a selection of concepts in a simplified form that are further described below in the Detailed Description. This Summary is not intended to identify key features of the claimed subject matter, nor is it intended to be used as an aid in determining the scope of the claimed subject matter.

In a first general aspect, an information processing system includes execution circuitry and a storage. The storage stores map data. The map data includes facility location information indicating a location of a specific facility, and parking lot location information indicating locations of multiple parking lots associated with the specific facility. The execution circuitry is configured to determine that a vehicle has been parked in any one of the parking lots. The execution circuitry is also configured to, when the vehicle is determined to have been parked in the parking lot, determine an approach route taken by the vehicle to reach the parking lot and an approach direction toward the parking lot on the approach route. The execution circuitry is also configured to calculate a parking frequency of the vehicle that is parked in the parking lot for each combination of the approach route, the approach direction, and the parking lot. Additionally, the execution circuitry is configured to store, in the storage, data related to the parking frequency in association with the map data for each combination of the approach route, the approach direction, and the parking lot.

With the above-described configuration, the parking frequency is calculated for each combination of the approach route, the approach direction, and the parking lot, instead of for each parking lot. Since the data related to the parking frequency of each combination is stored in association with the map data, it is possible to identify which parking lots are easier to use from which routes and from which directions. Thus, when there are multiple parking lots corresponding to a specific facility, the convenience for users is improved since it is possible to identify a parking lot that is easiest to use.

In a second general aspect, a controller for a vehicle includes execution circuitry and a storage. The storage stores map data. The map data includes facility location information indicating a location of a specific facility, and parking lot location information indicating locations of multiple parking lots associated with the specific facility. The execution circuitry is configured to determine that the vehicle has been parked in any one of the parking lots. The execution circuitry is also configured to, when the vehicle is parked in the parking lot, determine an approach route taken the vehicle to reach the parking lot and an approach direction toward the parking lot on the approach route. The execution circuitry is also configured to, each time the vehicle is parked in the parking lot, send a combination of the approach route, the approach direction, and the parking lot to outside.

In a third general aspect, a non-transitory computer-readable storage medium stores an information processing program that includes a command to be executed by an information processing system that includes execution circuitry. The storage medium stores map data. The map data includes facility location information indicating a location of a specific facility, and parking lot location information indicating locations of multiple parking lots associated with the specific facility. The command causes the execution circuitry to determine that a vehicle has been parked in any one of the parking lots. The command also causes the execution circuitry to, when the vehicle is parked in the parking lot, determine an approach route taken the vehicle to reach the parking lot and an approach direction toward the parking lot on the approach route. The command also causes the execution circuitry to calculate a parking frequency of the vehicle that is parked in the parking lot for each combination of the approach route, the approach direction, and the parking lot. Additionally, the command also causes the execution circuitry to store, in the storage medium, data related to the parking frequency in association with the map data for each combination of the approach route, the approach direction, and the parking lot.

Other features and aspects will be apparent from the following detailed description, the drawings, and the claims.

### BRIEF DESCRIPTION OF THE DRAWINGS

FIG. 1 is a schematic diagram of an information processing system according to an embodiment.

FIG. 2 is a sequence chart showing a parking determination control and a distribution control.

FIG. 3 is a flowchart showing the combination data generation control.

FIG. 4 is a flowchart showing exclusion data generation control.

FIG. 5 is a flowchart showing a selection control.

FIG. 6 is a flowchart showing a change control.

FIG. 7 is a diagram illustrating a specific facility and parking lots.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Overall Configuration of Information Processing System

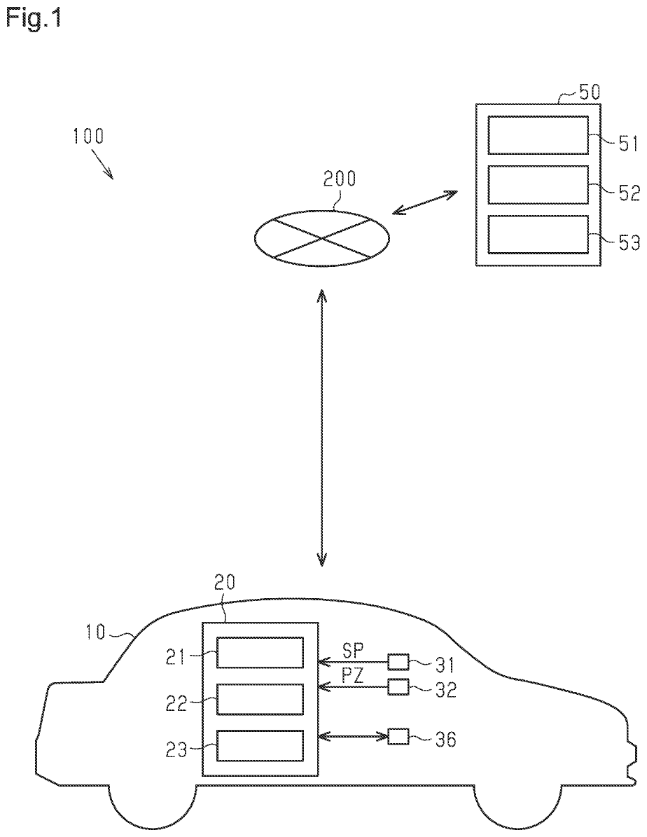

An embodiment of the present disclosure will now be described with reference to FIGS. 1 to 7. First, the schematic configuration of an information processing system 100 will be described.

As shown in FIG. 1, the information processing system 100 includes multiple vehicles 10. The vehicles 10 are, for example, automobiles owned by users. FIG. 1 shows only one of the vehicles 10.

Each vehicle 10 includes a vehicle speed sensor 31, a global navigation satellite system (GNSS) receiver 32, and a display 36. The vehicle speed sensor 31 detects a vehicle speed SP, which is the speed of the vehicle 10. The GNSS receiver 32 detects location coordinates PZ, which are the coordinates of the location where the vehicle 10 is situated, through communication with GNSS satellites (not shown). The display 36 displays various kinds of information. The display 36 is a touch screen. Therefore, the user can input various kinds of information via the display 36.

The vehicle 10 includes a controller 20. The controller 20 obtains various signals from the vehicle speed sensor 31, the GNSS receiver 32, and the display 36. Further, the controller 20 outputs control signals to the display 36 to display various types of information on the display 36.

The controller 20 includes an execution device 21, a storage 22, and a communication device 23. The communication device 23 is configured to communicate with devices outside the vehicle 10 via a communication network 200. The communication device 23 corresponds to a communication circuit.

The storage 22 stores data such as information obtained by the controller 20. The storage 22 stores various programs including commands to be executed by the execution device 21. Further, the storage 22 stores map data DM in advance. The storage 22 corresponds to a non-transitory computer-readable storage medium.

The map data DM includes information related to roads and information related to multiple facilities near roads. The information related to roads includes, for example, link data that connects two points of different coordinates. The information related to facilities includes information related to a specific facility Z and information related to multiple parking lots P associated with the specific facility Z. The information related to the specific facility Z includes various types of information such as a facility location information indicating the location of the specific facility Z. The information related to the parking lots P includes various types of information such as parking lot location information indicating the locations of the parking lots P. Each parking lot P includes multiple parking spaces. Thus, multiple vehicles 10 can be parked in each parking lot P.

The execution device 21 executes various processes by reading programs stored in the storage 22. In the present embodiment, one of the programs stored in the storage 22 is part of an information processing program executed by the information processing system 100. Thus, the execution device 21 executes part of the process executed by the information processing program. One example of the execution device 21 is a central processing unit (CPU). The execution device 21 corresponds to execution circuitry.

As shown in FIG. 1, the information processing system 100 includes a data center 50. An example of the data center 50 is a server. The data center 50 includes an execution device 51, a storage 52, and a communication device 53. The communication device 53 is configured to communicate with devices outside the data center 50 via the communication network 200.

The storage 52 stores data such as information obtained by the data center 50. The storage 52 stores various programs including commands to be executed by the execution device 51. Further, the storage 52 stores map data DM in advance. By executing a distribution control, which will be discussed below, the map data DM in the storage 52 is caused to agree with the map data DM in the storage 22. The storage 52 corresponds to a non-transitory computer-readable storage medium.

The execution device 51 executes various processes by reading programs stored in the storage 52. The programs stored in the storage 52 are part of the information processing program executed by the information processing system 100. Thus, the execution device 51 executes part of the processes executed by the information processing program. One example of the execution device 51 is a central processing unit (CPU). The execution device 51 corresponds to execution circuitry.

Parking Determination Control

Next, a parking determination control executed by the controllers 20 of the vehicles 10 and the data center 50 will be described. The parking determination control is executed through interactions between the controller 20 of each of the vehicles 10 and the single data center 50. Each time a vehicle 10 starts to move, the controller 20 of the vehicle 10 executes the parking determination control once.

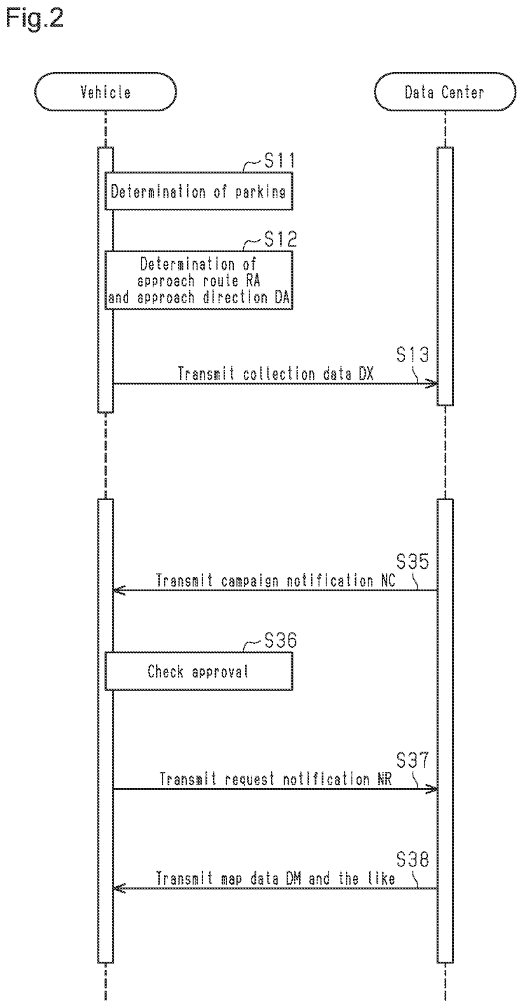

As shown in FIG. 2, when starting the parking determination control, the execution device 21 of the controller 20 executes the process of step S11. In step S11, the execution device 21 of the controller 20 determines that the vehicle 10 has been parked in any one of the parking lots P. For example, the execution device 21 of the controller 20 determines that the vehicle 10 has been parked in any one of the parking lots P based on the map data DM and information related to the behavior of the vehicle 10 such as the vehicle speed SP and the location coordinates PZ. For example, the execution device 21 determines that the vehicle 10 has been parked in a parking lot P when conditions are met that include the location coordinates PZ agreeing with the parking lot location information of the parking lot P stored in the map data DM and the vehicle speed SP being zero for a predetermined time or longer. After step S11, the execution device 21 of the controller 20 advances the process to step S12. In other words, when the vehicle 10 has been parked in a parking lot P, the execution device 21 of the controller 20 advances the process to step S12.

In step S12, the execution device 21 of the controller 20 determines an approach route RA taken by the vehicle 10 to reach the parking lot P and an approach direction DA toward the parking lot P on the approach route RA. For example, based on the history of the location coordinates PZ from a certain period before the vehicle 10 is parked in the parking lot P, the execution device 21 of the controller 20 determines, as the approach route RA, the route from the point where the vehicle 10 was located during the certain period before to the parking lot P. Further, for example, based on the history of the location coordinates PZ, the execution device 21 of the controller 20 determines, as the approach direction DA, a direction in which the vehicle 10 approached the parking lot P on the approach route RA. After step S12, the execution device 21 of the controller 20 advances the process to step S13.

In step S13, the execution device 21 of the controller 20 transmits, to the data center 50, collection data DX, which is information combining the approach route RA, the approach direction DA, and the parking lot P where the vehicle 10 has been parked. In other words, each time the vehicle 10 is parked in a parking lot P, the execution device 21 of the controller 20 transmits, to the outside of the vehicle 10, the collection data DX, which is information combining the approach route RA, the approach direction DA, and the parking lot P. When the data center 50 receives the collection data DX from the controller 20, the execution device 51 of the data center 50 is capable of determining that the vehicle 10 has been parked in one of the parking lots P. Further, the execution device 51 of the data center 50 is capable of determining the approach route RA taken by the vehicle 10 to reach the parking lot P and the approach direction DA toward the parking lot P on the approach route RA. Further, the execution device 51 of the data center 50 stores the collection data DX in the storage 52. Although FIG. 2 shows that the collection data DX is transmitted from one vehicle 10 to the data center 50, multiple vehicles 10 actually transmit the collection data DX to the data center 50 in parallel. After step S12, the data center 50 terminates the current parking determination control.

Combination Data Generation Control

A combination data generation control executed by the data center 50 will now be described. The data center 50 repeats the combination data generation control at specified intervals determined in advance. One example of the predetermined period is about several days to several tens of days.

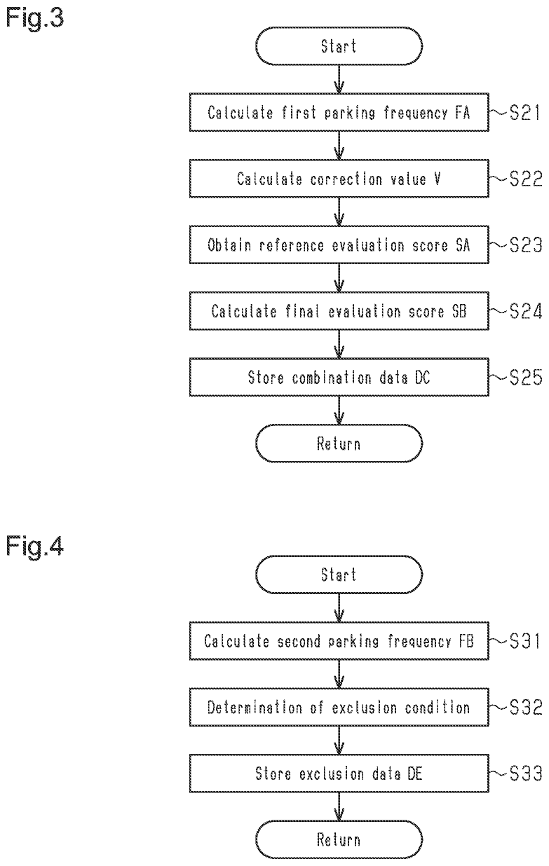

As shown in FIG. 3, when starting the combination data generation control, the execution device 51 of the data center 50 executes the process of step S21. In step S21, based on multiple sets of the collection data DX, the execution device 51 of the data center 50 calculates a first parking frequency FA, which is the parking frequency of the vehicles 10 parked in parking lots P during a first reference period TA, for each combination of the approach route RA, the approach direction DA, and the parking lot P. The parking frequency of the vehicles 10 refers to the frequency at which the vehicles 10 are parked in parking lots P that are available by using the same approach route RA and the same approach direction DA during a predetermined period.

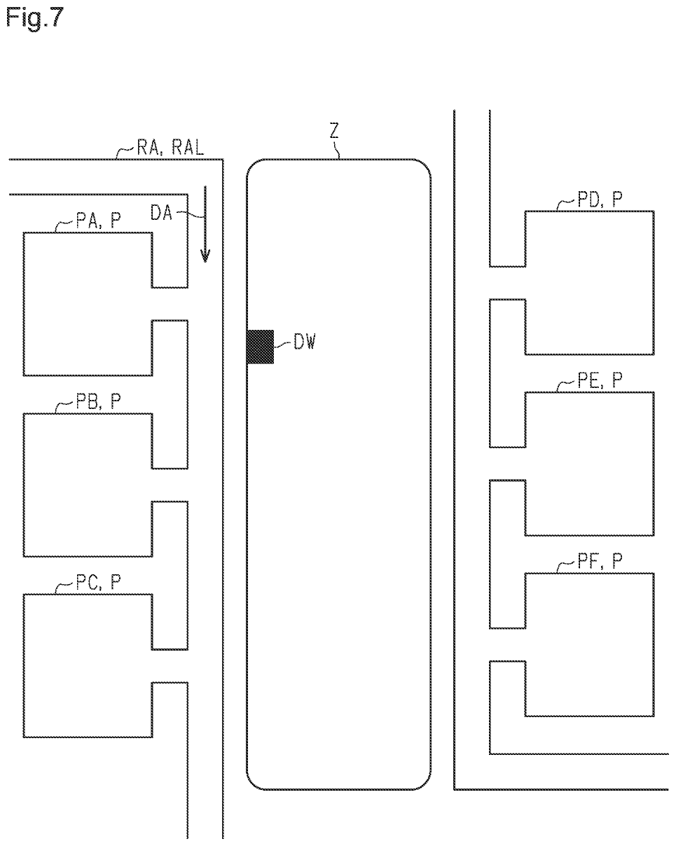

For example, FIG. 7 illustrates a case in which a specific facility Z is associated with six parking lots P including first to sixth parking lots PA to PF. Of the six parking lots P, the first parking lot PA to the third parking lot PC are reachable using a left-side route RAL, which is located on the left side of the specific facility Z as viewed in FIG. 7. When reaching any of the first parking lot PA to the third parking lot PC using the left-side route RAL, there are a case in which a vehicle reaches there by traveling in the downward direction as viewed in FIG. 7 and a case in which a vehicle reaches there by traveling in the upward direction as viewed in FIG. 7. Accordingly, the execution device 51 calculates the first parking frequency FA for a combination of the parking lot P being the first parking lot PA, the approach route RA being the left-side route RAL, and the approach direction DA being the downward direction. Likewise, the execution device 51 calculates the first parking frequency FA for a combination of the parking lot P being the first parking lot PA, the approach route RA being the left-side route RAL, and the approach direction DA is the upward direction.

In the present embodiment, when calculating the first parking frequency FA, the execution device 51 counts, from the sets of the collection data DX obtained during the first reference period TA, the number of sets of data for each combination of the approach route RA, the approach direction DA, and the parking lot P. Further, from the sets of the collection data DX obtained during the first reference period TA, the execution device 51 counts the total number of sets of data that includes the same approach route RA and the same approach direction DA as a target combination. Then, the execution device 51 calculates the first parking frequency FA by dividing the number of sets of data corresponding to a combination of the approach route RA, the approach direction DA, and the parking lot P by the total number of sets of data corresponding to the same approach route RA and the same approach direction DA. Although the first parking lot PA has been described as an example, the execution device 51 calculates the first parking frequency FA for all the combinations of the parking lot P, the approach route RA, and the approach direction DA. The execution device 51 stores the calculated first parking frequency FA in the storage 52. In the present embodiment, one example of the first reference period TA is a period from a few months before to the point in time at which step S21 is executed. After step S21, the execution device 51 advances the process to step S22 as shown in FIG. 3.

As shown in FIG. 3, in step S22, the execution device 51 calculates a correction value V based on the first parking frequency FA. Specifically, the execution device 51 calculates a greater value of the correction value V as the first parking frequency FA increases. A greater value of the correction value V corresponds to a higher evaluation. As such, the greater the correction value V, the higher a final evaluation score SB, which will be discussed below, becomes. The execution device 51 calculates the correction value V for each combination of the approach route RA, the approach direction DA, and the parking lot P. After step S22, the execution device 51 advances the process to step S23.

In step S23, the execution device 51 obtains a reference evaluation score SA. In the present embodiment, the storage 52 stores, in advance, reference evaluation scores SA that correspond to the respective parking lots P. The execution device 51 obtains a reference evaluation score SA by accessing the storage 52. The reference evaluation score SA, which is stored in the storage 52, increases as the distance from an entrance DW of the specific facility Z to a parking lot P decreases. As the reference evaluation score SA increases, a final evaluation score SB, which will be discussed below, becomes higher. Specifically, in the example shown in FIG. 7, the distance between the center of each parking lot P and the center of the entrance DW decreases in the order of the third parking lot PC, the second parking lot PB, and the first parking lot PA. Thus, the reference evaluation score SA also increases in the order of the third parking lot PC, the second parking lot PB, and the first parking lot PA. After step S23, the execution device 51 advances the process to step S24 as shown in FIG. 3.

As shown in FIG. 3, in step S24, the execution device 51 calculates the final evaluation score SB based on the reference evaluation score SA and the correction value V. In the present embodiment, the execution device 51 sets the final evaluation score SB to the sum of the reference evaluation score SA and the correction value V. The execution device 51 calculates the final evaluation score SB for each combination of the approach route RA, the approach direction DA, and the parking lot P. After step S24, the execution device 51 advances the process to step S25.

In step S25, the execution device 51 generates combination data DC, which is information associating the combination of the approach route RA, the approach direction DA, and the parking lot P with the final evaluation score SB corresponding to the combination. The execution device 51 associates the combination data DC with the map data DM and stores the combination data DC in the storage 52. As described above, the final evaluation score SB is based on the first parking frequency FA. Therefore, in step S25, the execution device 51 associates the data related to the first parking frequency FA with the map data DM for each combination of the approach route RA, the approach direction DA, and the parking lot P, and stores the data in the storage 52. After step S25, the execution device 51 terminates the current combination data generation control.

Exclusion Data Generation Control

An exclusion data generation control executed by the data center 50 will now be described. The data center 50 repeats the exclusion data generation control at predetermined control cycles. One example of the control cycle is about several milliseconds to several seconds.

As shown in FIG. 4, when starting the exclusion data generation control, the execution device 51 of the data center 50 executes the process of step S31. In step S31, the execution device 51 of the data center 50 calculates a second parking frequency FB, which is the parking frequency of the vehicles 10 parked in parking lots P during a second reference period TB, for each combination of the approach route RA, the approach direction DA, and the parking lot P. The contents of the process of step S31 are the same as the contents of the process of step S21 except for the period for which the parking frequency is calculated.

In the present embodiment, the example of the second reference period TB is a period from several tens of minutes before to the point in time at which step S31 is executed. Therefore, the second reference period TB is shorter than the first reference period TA. The commencement of the second reference period TB is after the commencement of the first reference period TA. The termination of the second reference period TB is at or after the termination of the first reference period TA. Thus, as compared to the first parking frequency FA, the second parking frequency FB reflects a period closer to the point in time at which the process of step S31 is executed. In other words, the second parking frequency FB reflects the current parking frequency as compared to the first parking frequency FA. After step S31, the execution device 51 advances the process to step S32.

In step S32, the execution device 51 determines whether a predetermined exclusion condition is met for each combination of the approach route RA, the approach direction DA, and the parking lot P. The execution device 51 determines that the exclusion condition is met, for example, when both of the following two conditions are met.

Condition (1): The second parking frequency FB is lower than the first parking frequency FA.

Condition (2): The difference between the second parking frequency FB and the first parking frequency FA is greater than or equal to a prescribed difference.

For example, a case will now be described in which a parking lot P can no longer be used because it is full or under repair. In this case, the second parking frequency FB quickly decreases even if the first parking frequency FA is relatively high. In this case, the above exclusion condition is met. After step S32, the execution device 51 advances the process to step S33.

In step S33, the execution device 51 stores, in the storage 52, information indicating whether each parking lot P is subject to exclusion for each combination of the approach route RA, the approach direction DA, and the parking lot P. Specifically, the execution device 51 defines all the combinations including the parking lots P that meet the exclusion condition in step S32 as combinations to be excluded. On the other hand, when there is no parking lot P that meets the exclusion condition in step S32, the execution device 51 removes all the combinations from the exclusion list. After step S33, the execution device 51 terminates the current exception data generation control.

Distribution Control

Next, a distribution control executed by the data center 50 and the controller 20 of each of the vehicles 10 will be described. The distribution control is executed concurrently through interactions between the single data center 50 and the controllers 20 of the respective vehicles 10. The data center 50 executes a distribution control each time one or more of the map data DM, the combination data DC, and the exclusion data DE are updated.

As shown in FIG. 2, when starting the distribution control, the execution device 51 of the data center 50 executes the process of step S35. In step S35, the execution device 51 of the data center 50 transmits a campaign notification NC to the controller 20 of each vehicle 10. The campaign notification NC is used to notify the user of the vehicle 10 of a software update related to the information processing system 100 such as the map data DM, the combination data DC, and the exclusion data DE.

When receiving the campaign notification NC, the execution device 21 of the controller 20 executes the process of step S36. In step S36, the execution device 21 of the controller 20 displays options to approve or decline the execution of a software update on the display 36. When the user does not approve the software update, the execution device 21 of the controller 20 displays the above options on the display 36 at certain intervals. When the user approves the software update, the execution device 21 of the controller 20 advances the process to step S37.

In step S37, the execution device 21 of the controller 20 transmits a request notification NR to the data center 50. The request notification NR is used to notify the execution device 51 of the data center 50 that the user has approved an update of the map data DM, the combination data DC, and the exclusion data DE.

When receiving the request notification NR, the execution device 51 of the data center 50 advances the process to step S38. In step S38, the execution device 51 of the data center 50 transmits the map data DM, the combination data DC, and the exclusion data DE to the controller 20 of the vehicle 10. When receiving the map data DM, the combination data DC, and the exclusion data DE, the execution device 21 of the controller 20 stores the map data DM, the combination data DC, and the exclusion data DE in the storage 22. At this time, if the storage 22 has already stored the map data DM, the combination data DC, and the exclusion data DE, the execution device 21 overwrites the map data DM, the combination data DC, and the exclusion data DE with the new data. Thereafter, the execution device 21 of the controller 20 terminates the current distribution control.

Selection Control

A selection control executed by the controller 20 of each vehicle 10 will now be described. For example, the controller 20 of the vehicle 10 executes the selection control once each time the user operates the display 36 to set the specific facility Z as the destination of the vehicle 10.

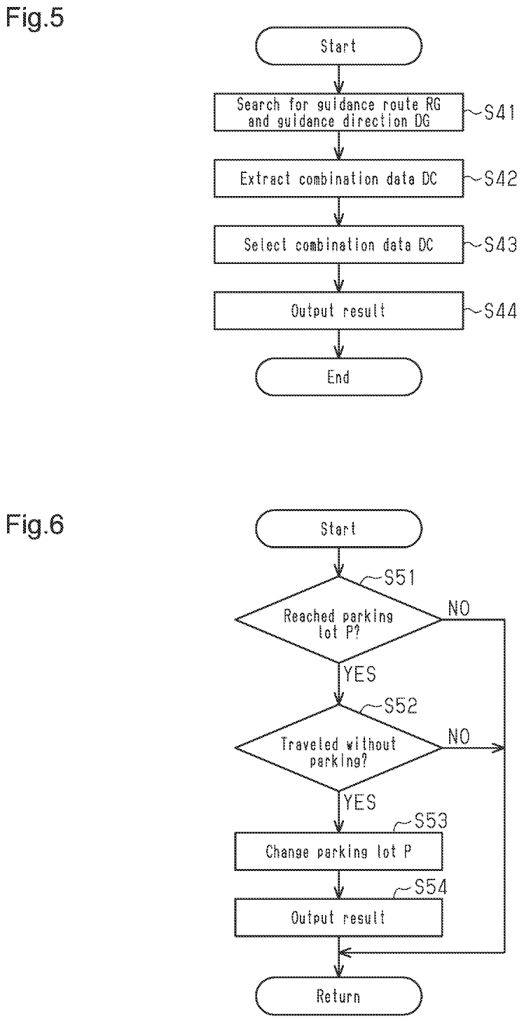

As shown in FIG. 5, when starting the selection control, the execution device 21 of the controller 20 executes the process of step S41. In step S41, based on the map data DM, the location coordinates PZ, and the like, the execution device 21 searches for a guidance route RG from the current location of the vehicle 10 to each of the parking lots P associated with the specific facility Z, and a guidance direction DG on the guidance route RG. The execution device 21 searches for the guidance route RG and the guidance direction DG such that a predetermined condition, for example, a condition that the travel distance is the shortest, is met. After step S41, the execution device 21 advances the process to step S42.

In step S42, the execution device 21 accesses the storage 22 to obtain the combination data DC that is stored in association with the map data DM. Then, the execution device 21 extracts, from multiple sets of the combination data DC, the combination data DC that agrees with the combination of the guidance route RG and the guidance direction DG. Specifically, the execution device 21 extracts a set of the combination data DC in which the combination of the approach route RA and the approach direction DA agrees with the combination of the guidance route RG and the guidance direction DG in the vicinity of the specific facility Z.

For example, FIG. 7 illustrates an example in which the combination of the guidance route RG and the guidance direction DG in the vicinity of the specific facility Z agrees with the combination of the approach route RA being the left-side route RAL and the approach direction DA being the downward direction in multiple sets of the combination data DC. In this case, the execution device 51 extracts the combination data DC related to the approach route RA being the left-side route RAL, the approach direction DA being the downward direction, and the parking lot P being the first parking lot PA. Also, the execution device 51 extracts the combination data DC related to the approach route RA being the left-side route RAL, the approach direction DA being the upward direction, and the parking lot P being the second parking lot PB. Further, the execution device 51 extracts the combination data DC related to the approach route RA being the left-side route RAL, the approach direction DA being the downward direction, and the parking lot P being the third parking lot PC. After step S42, the execution device 21 advances the process to step S43 as shown in FIG. 5.

As shown in FIG. 5, in step S43, the execution device 21 selects one of the sets of the combination data DC extracted in step S42. Specifically, the execution device 21 obtains the exclusion data DE by accessing the storage 22. Further, based on the exclusion data DE, the execution device 21 identifies remaining sets of the combination data DC extracted in step S42, excluding sets of the combination data DC that contain the parking lots P to be excluded. Based on the final evaluation scores SB included in the combination data DC, the execution device 21 selects one of the identified sets of the combination data DC that has the highest final evaluation score SB. As described above, the final evaluation scores SB are based on the first parking frequency FA. Therefore, in step S43, the execution device 21 selects one of the sets of the combination data DC extracted in step S42 based on the first parking frequency FA. After step S43, the execution device 21 advances the process to step S44.

In step S44, the execution device 21 sets the parking lot P included in the combination data DC selected in step S43 as the destination of the vehicle 10. Further, the execution device 21 searches for the final guidance route RG and the final guidance direction DG based on the set destination, and the approach route RA and the approach direction DA included in the combination data DC selected in step S43. Then, the execution device 21 outputs the final guidance route RG and the final guidance direction DG as navigation data for the specific facility Z. Specifically, the execution device 21 outputs a control signal to the display 36. As a result, the display 36 displays the navigation data based on the control signal.

Change Control

A change control executed by the controller 20 of the vehicle 10 will now be described. After terminating the selection control, the controller 20 of the vehicle 10 repeatedly executes the change control. If the controller 20 determines that the vehicle 10 has been parked in the parking lot P that has been set as a destination, the controller 20 terminates the change control.

As shown in FIG. 6, when starting the change control, the execution device 21 of the controller 20 executes the process of step S51. In step S51, based on the map data DM, the location coordinates PZ, and the like, the execution device 21 determines whether the vehicle 10 has reached the parking lot P that has been set as the destination. Specifically, the execution device 21 determines that the vehicle 10 has reached the parking lot P that has been set as the destination when the vehicle 10 has entered a specified range determined in advance with respect to the center of the parking lot P that has been set as the destination. One example of the specified range is from several meters to about a dozen meters. In step S51, if the execution device 21 determines that the vehicle 10 has not reached the parking lot P that has been set as the destination (S51: NO), the execution device 21 executes the process of step S51 again. If the execution device 21 determines in step S51 that the vehicle 10 has reached the parking lot P that has been set as the destination (S51: YES), the execution device 21 advances the process to step S52.

In step S52, based on the map data DM, the location coordinates PZ, and the like, the execution device 21 determines whether the vehicle 10 has traveled without being parked in the parking lot P that has been set as the destination. Specifically, the execution device 21 determines that the vehicle 10 has traveled without being parked in the parking lot P that has been set as the destination when the vehicle 10 has exited a specified range determined in advance with respect to the center of the parking lot P as the destination. In the present embodiment, the specified range of step S52 is the same as that of step S51. In step S52, if the execution device 21 does not determine that the vehicle 10 has traveled without being parked in the parking lot P that has been set as the destination (S52: NO), the execution device 21 executes the process of step S51 again. In step S52, if the execution device 21 determines that the vehicle 10 has traveled without being parked in the parking lot P that has been set as the destination (S52: YES), the execution device 21 advances the process to step S53.

In step S53, the execution device 21 sets a new destination to a parking lot P that is associated with the specific facility Z and is different from the parking lot P in which the vehicle 10 was not parked in step S52. Specifically, the execution device 21 extracts, from multiple parking lots P associated with the specific facility Z, parking lots P that are available by using the same approach route RA and the same approach direction DA. From among the extracted parking lots P, the execution device 21 identifies the parking lot P that is closest from the location of the vehicle 10 at the time of execution of step S53 on the same approach route RA and in the same approach direction DA. Then, the execution device 21 sets the identified parking lot P as a new destination.

For example, FIG. 7 shows a case in which, as indicated by the solid arrow, the vehicle 10 is advancing in the approach direction DA being a downward direction as viewed in FIG. 7 along the left-side route RAL, which is on the left side of the specific facility Z as viewed in FIG. 7. The parking lot P in which the vehicle 10 was not parked in step S52 is the first parking lot PA. At this time, the execution device 21 extracts, from the six parking lots P associated with the specific facility Z, the second parking lot PB and the third parking lot PC as the parking lots P that are available by using the same approach route RA and the same approach direction DA, excluding the first parking lot PA. Of the extracted second parking lot PB and the extracted third parking lot PC, the execution device 21 identifies the second parking lot PB as the parking lot P closest to the location of the vehicle 10 at the time of execution of step S53. Then, the execution device 21 sets the identified second parking lot PB as a new destination. After step S53, the execution device 21 advances the process to step S54 as shown in FIG. 6.

As shown in FIG. 6, in step S54, the execution device 21 searches for a new guidance route RG and a new guidance direction DG based on the approach route RA and the approach direction DA, which were used in step S53, and the destination set in step S53. Then, the execution device 21 outputs the new guidance route RG and the new guidance direction DG as the navigation data for the specific facility Z. Specifically, the execution device 21 outputs a control signal to the display 36. As a result, the display 36 displays the navigation data based on the control signal.

### Operation of Present Embodiment

As shown in FIG. 2, in the parking determination control, the execution device 21 of the controller 20 transmits, to the data center 50, collection data DX, which is information combining the approach route RA, the approach direction DA, and the parking lot P. The data center 50 obtains the collection data DX from the controllers 20 of multiple vehicles 10. As a result, the storage 52 of the data center 50 stores a large amount of the collection data DX. As shown in FIG. 3, in the combination data generation control, the execution device 51 calculates the first parking frequency FA for each combination of the approach route RA, the approach direction DA, and the parking lot P based on multiple sets of the collection data DX during the first reference period TA. The execution device 51 calculates the final evaluation score SB of each combination based on the first parking frequency FA. Further, the execution device 51 generates combination data DC, which is information associating the combination of the approach route RA, the approach direction DA, and the parking lot P with the final evaluation score SB corresponding to the combination. The execution device 51 associates the combination data DC with the map data DM and stores the combination data DC in the storage 52.

### Aspects of Present Embodiment

(1) In the present embodiment, the first parking frequency FA, which is used to calculate the final evaluation score SB of the combination data DC, is calculated not for each parking lot P, but for each combination of the approach route RA, the approach direction DA, and the parking lot P. Since the data related to the first parking frequency FA of each combination is stored in association with the map data DM, it is possible to identify which parking lots are more convenient to use from which routes and in which directions. Thus, when there are multiple parking lots P corresponding to the specific facility Z, the convenience for users is improved since it is possible to identify a parking lot P that is easiest to use.

(2) As shown in FIG. 5, in the selection control, the execution device 21 of the controller 20 sets a parking lot P as a destination of the vehicle 10 based on the final evaluation score SB, which takes into consideration the first parking frequency FA. The higher the first parking frequency FA, which is calculated for each of the approach route RA and the approach direction DA, the more frequently users park their vehicles 10 in the corresponding parking lot P. In other words, as the first parking frequency FA of the corresponding parking lot P increases, the parking lot P tends to have a higher convenience for the users. Therefore, based on the first parking frequency FA, the parking lot P that is convenient for the users is likely to be set as a destination.

(3) As shown in FIG. 3, in the combination data generation control, the execution device 51 of the data center 50 calculates the final evaluation score SB using the reference evaluation score SA in addition to the correction value V based on the first parking frequency FA. The reference evaluation score SA is a value that reflects the distance between entrance DW of the specific facility Z and the parking lot P. Accordingly, for example, the parking lot P having high convenience in that the distance between the entrance DW of the specific facility Z and the parking lot P is short is preferentially set as the destination.

(4) For example, FIG. 7 shows a case in which, as indicated by the solid arrow, the vehicle 10 is advancing in the approach direction DA being a downward direction as viewed in FIG. 7 along the left-side route RAL, which is on the left side of the specific facility Z as viewed in FIG. 7. A case will now be considered in which the first parking lot PA to the third parking lot PC can be used, and the first parking frequency FA that corresponds to the first parking lot PA is relatively high. If the first parking lot PA cannot be used for some reason or if the first parking lot PA cannot be used easily, the current parking frequency corresponding the first parking lot PA tends decreases. In other words, the second parking frequency FB during the second reference period TB is lower than the first parking frequency FA during the first reference period TA.

As shown in FIG. 4, in the exclusion data generation control, the execution device 51 of the data center 50 determines whether the exclusion condition is met, the exclusion condition being that the second parking frequency FB is lower than the first parking frequency FA and that the difference between the second parking frequency FB and the first parking frequency FA is greater than or equal to a prescribed difference. The execution device 51 of the data center 50 generates the exclusion data DE, which indicates that the parking lot P meeting the exclusion condition should be excluded. As shown in FIG. 5, in the selection control, the execution device 21 of the controller 20 sets a parking lot P as a destination of the vehicle 10 after excluding the parking lot P to be excluded based on the exclusion data DE. This prevents a parking lot P that cannot be used in the current situation from being set as a destination in the selection control.

(5) Due to some factors, the vehicle 10 may continue to travel away from the first parking lot PA without being parked in the first parking lot PA, which has been set as a destination. In such a case, the convenience of the first parking lot PA may not be high to the user of the vehicle 10 at that time.

In this regard, as shown in FIG. 6, in the change control, when the vehicle 10 travels without being parked in the first parking lot PA, which has been set as a destination of the vehicle 10, the controller 20 of the execution device 21 changes the destination to a parking lot P that is different from the parking lot P in which the vehicle 10 was not parked. As a result, it is possible to prevent the occurrence of a situation in which the first parking lot PA keeps being suggested to be destination even though the user no longer wishes to park the vehicle 10 in the first parking lot PA for some reason.

(6) In the change control, when the vehicle 10 is not parked in the parking lot P that is the initial destination, the execution device 21 of the controller 20 extracts parking lots P that are available by using the same approach route RA and the same approach direction DA. From among the available parking lots P, the execution device 21 of the controller 20 sets, as a new destination, a parking lot P that is closest to the vehicle 10 along the same approach route RA and in the same approach direction DA from the location of the vehicle 10. In other words, the execution device 21 of the controller 20 changes the destination to another parking lot P, one that is next in line along the approach direction DA, distinct from the parking lot P where the vehicle 10 was not parked. Thus, for example, the user does not need to move the vehicle 10 in a direction opposite to the approach direction DA.

Modifications

The above-described embodiment may be modified as follows. The above-described embodiment and the following modifications can be combined if the combined modifications remain technically consistent with each other.

In the above-described embodiment, the parking determination control may be changed.

For example, the controller 20 may change the time at which the collection data DX is transmitted to the data center 50. Specifically, the execution device 21 of the controller 20 may transmit the collection data DX to the data center 50 when the controller 20 stops operating.

For example, the data that the controller 20 transmits to the data center 50 may be changed. Specifically, the execution device 21 of the controller 20 may transmit only information related to the behavior of the vehicle 10 such as the vehicle speed SP and the location coordinates PZ to the data center 50. In this case, the execution device 51 of the data center 50 may determine that the vehicle 10 has been parked in any one of the parking lots P based on the map data DM and information related to the behavior of the vehicle 10 such as the vehicle speed SP and the location coordinates PZ. The execution device 51 of the data center 50 simply needs to determine the approach route RA and the approach direction DA based on the history of the location coordinates PZ. The execution device 51 of the data center 50 simply needs to generate the collection data DX, which is information combining the approach route RA, the approach direction DA, and the parking lot P.

In the above-described embodiment, the combination data generation control may be changed.

For example, the value indicated by the reference evaluation score SA may be changed. Specifically, instead of or in addition to the distance between the entrance DW of the specific facility Z and the parking lot P, the reference evaluation score SA may be obtained by taking into consideration, for example, the size of the parking lot P, the width of the entrance passage of the parking lot P, and the distance of the entrance passage of the parking lot P.

For example, the execution device 51 of the data center 50 does not necessarily need to use the reference evaluation score SA. That is, the execution device 51 of the data center 50 may calculate the final evaluation score SB based on only the first parking frequency FA.

In the above-described embodiment, the exclusion data generation control may be changed.

For example, the exclusion condition may be changed. Specifically, the execution device 51 of the data center 50 may determine that the exclusion condition is met when one or more of Conditions (1) and (2) are met.

In the above-described embodiment, the exclusion data generation control may be omitted.

Specifically, depending on the specific facility Z or the like to be used, the difference between the second parking frequency FB during the second reference period TB and the first parking frequency FA during the first reference period TA does not often increase to a significant extent. In such a case, omission of the exclusion data generation control would have a small impact.

In the above-described embodiment, the distribution control may be changed.

For example, the time at which the distribution control is executed may be changed. Specifically, if the user agrees in advance to allow automatic execution of the software updates, the data center 50 may repeatedly execute the distribution control at each predetermined control cycle. In this case, in step S36, the execution device 21 of the controller 20 simply needs to advance the process to step S37 without displaying options on the display 36.

In the above-described embodiment, the selection control may be changed.

For example, in step S43, based on the final evaluation scores SB included in the combination data DC, the execution device 21 of the controller 20 may select one of the identified sets of the determined combination data DC that has the second highest final evaluation score SB. As one example, a case will be described in which the difference between the final evaluation score SB of the highest evaluation and the final evaluation score SB of the second highest evaluation is relatively small, and the second parking frequency FB for the parking lot P corresponding to the final evaluation score SB of the second highest evaluation is relatively low. In this case, there is a possibility that the vacancy rate of the parking lot P corresponding to the final evaluation score SB having the second highest evaluation is high. That is, the parking lot P corresponding to the final evaluation score SB having the second highest evaluation may have a high convenience for the user.

For example, if the exclusion data generation control is omitted as described above, the execution device 21 of the controller 20 simply needs to set a parking lot P as a destination of the vehicle 10 in step S43 without excluding parking lots P based on the exclusion data DE.

In the above-described embodiment, the change control may be changed.

For example, the specified range in step S51 may be narrower than the specified range in step S52.

In the above-described embodiment, the change control may be omitted.

For example, in a case in which the necessity of the change control is low, the execution device 21 of the controller 20 does not necessarily need to execute the change control.

In the above-described embodiment, the configuration of the information processing system 100 may be changed.

For example, the information processing system 100 does not necessarily need to include the data center 50. Specifically, since the controllers 20 of multiple vehicles 10 communicate with each other, the execution device 21 of each controller 20 may be capable of performing the combination data generation control and the like.

In the above-described embodiment, focusing only on the vehicles 10, it is effective for the execution device 21 of the controller 20 to execute not only the processes of steps S11 and S12 in the parking determination control but also the process of transmitting the collection data DX to the outside in step S13. Specifically, if the collection data DX can be obtained by the above process, for example, an external device such as the data center 50, an external device such as the data center 50 can calculate the first parking frequency FA based on the collection data DX. An external device such as the data center 50 can generate combination data DC that includes the calculated first parking frequency FA.

The controller 20 is not limited to a device that includes the execution device 21, the storage 22, and the communication device 23 and executes software processing. For example, at least part of the processes executed by the software in the above-described embodiment may be executed by hardware circuits dedicated to executing these processes (such as an application-specific integrated circuit (ASIC)). That is, the controller 20 may be modified as long as it has any one of the following configurations (a) to (c). (a) A configuration including a processor that executes all of the above-described processes according to programs and a program storage device such as a ROM (including a non-transitory computer-readable storage medium) that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. One or any desired number of software processing devices that each include a processor and a program storage device and one or any desired number of dedicated hardware circuits may be provided.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processing system, comprising:
execution circuitry; and
a storage, wherein
the storage stores map data,
the map data includes:
facility location information indicating a location of a specific facility; and
parking lot location information indicating locations of multiple parking lots associated with the specific facility, and
the execution circuitry is configured to
determine that a vehicle has been parked in any one of the parking lots,
when the vehicle is determined to have been parked in the parking lot, determine an approach route taken by the vehicle to reach the parking lot and an approach direction toward the parking lot on the approach route,
calculate a parking frequency of the vehicle that is parked in the parking lot for each combination of the approach route, the approach direction, and the parking lot, and
store, in the storage, data related to the parking frequency in association with the map data for each combination of the approach route, the approach direction, and the parking lot.

2. The information processing system according to claim 1, wherein
the execution circuitry is configured to execute, when a destination of the vehicle is set to the specific facility is set
search for, from a current location of the vehicle, a guidance route to each parking lot associated with the specific facility and a guidance direction on the guidance route,
extract, from the combinations stored in the storage, combinations that agree with the combination of the guidance route and the guidance direction,
select one of the extracted combinations based on the parking frequency, and
output navigation data for the specific facility based on the approach route and the approach direction included in the selected combination, the navigation data including, as a destination, the parking lot included in the selected combination.

3. The information processing system according to claim 2, wherein the execution circuitry is configured to select, from the extracted combinations, a combination in which the parking frequency is the highest.

4. The information processing system according to claim 2, wherein
the storage stores an evaluation score of each of the respective parking lots,
the evaluation score is a value that indicates a higher evaluation as a distance between an entrance and the parking lot of the specific facility decreases, and
the execution circuitry is configured to
for each of the combinations, calculate a correction value that indicates a higher evaluation as the parking frequency increases, and
select one of the combinations in which evaluation based on the evaluation score of the parking lot and the correction value for the combination is highest.

5. The information processing system according to claim 2, wherein
a period in which the parking frequency is stored in the storage in association with the map data is defined to as a first reference period,
a period shorter than the first reference period is defined as a second reference period,
a commencement of the second reference period is after a commencement of the first reference period,
a termination of the second reference period is at or after a termination of the first reference period, and
the execution circuitry is configured to
calculate, for the second reference period, a parking frequency of the vehicle that is parked in the parking lot for each combination of the approach route, the approach direction, and the parking lot,
determine whether each combination of the approach route, the approach direction, and the parking lot meets an exclusion condition, the exclusion condition including the parking frequency during the second reference period being lower than the parking frequency during the first reference period, and a difference between the parking frequency during the second reference period and the parking frequency during the first reference period being greater than or equal to a prescribed difference, and
select one of the extracted combinations after excluding the combinations that meet the exclusion condition.

6. The information processing system according to claim 2, wherein
the execution circuitry is configured to
determine whether the vehicle has reached the parking lot, which has been set as a destination, after outputting the navigation data for the specific facility,
determine whether the vehicle has traveled without being parked in the parking lot after the determination that the vehicle has reached the parking lot, and
when determining that the vehicle has traveled without being parked in the parking lot, output navigation data for a new destination, the new destination being a parking lot associated with the specific facility and different from the parking lot in which the vehicle was not parked.

7. A controller for a vehicle, comprising:
execution circuitry; and
a storage, wherein
the storage stores map data,
the map data includes:
facility location information indicating a location of a specific facility; and
parking lot location information indicating locations of multiple parking lots associated with the specific facility, and
the execution circuitry is configured to
determine that the vehicle has been parked in any one of the parking lots,
when the vehicle is parked in the parking lot, determine an approach route taken the vehicle to reach the parking lot and an approach direction toward the parking lot on the approach route, and
each time the vehicle is parked in the parking lot, send a combination of the approach route, the approach direction, and the parking lot to outside.

8. A non-transitory computer-readable storage medium that stores an information processing program that includes a command to be executed by an information processing system that includes execution circuitry, wherein
the storage medium stores map data,
the map data includes:
facility location information indicating a location of a specific facility; and
parking lot location information indicating locations of multiple parking lots associated with the specific facility, and
the command causes the execution circuitry to determine that a vehicle has been parked in any one of the parking lots,
when the vehicle is parked in the parking lot, determine an approach route taken the vehicle to reach the parking lot and an approach direction toward the parking lot on the approach route, and
calculate a parking frequency of the vehicle that is parked in the parking lot for each combination of the approach route, the approach direction, and the parking lot, and
store, in the storage medium, data related to the parking frequency in association with the map data for each combination of the approach route, the approach direction, and the parking lot.
